(19) United States
(12) Patent Application Publication
(10) Pub. No.: US 2021/0129595 A1
(43) Pub. Date: May 6, 2021

(54) SOLID TIRE PROVIDED WITH MEANS FOR SIGNALLING THE STATE OF EXCESSIVE WEAR

(71) Applicant: TRELLEBORG WHEEL SYSTEMS ITALIA S.P.A., Tivioli-Villa Adriana (RM) (IT)

(72) Inventors: Gianluca ABBATI, COLLEFERRO (RM) (IT); Gianluca MELORO, GUIDONIA MONTECELIO (RM) (IT); Dinesh GUNASEKARA, PILIMATHALAWA (LK); Sumudu PRADEEPA, Kochchikade (LK); Mario SGRECCIA, MARINO (RM) (IT)

(21) Appl. No.: 17/078,614

(22) Filed: Oct. 23, 2020

(30) Foreign Application Priority Data
Oct. 30, 2019 (IT) 102019000020092

(51) Int. Cl. B60C 11/24; B60C 1/00; C08K 3/36; C08L 21/00

(52) U.S. Cl. CPC B60C 11/24; C08L 21/00; C08K 3/36; B60C 1/0016

(57) ABSTRACT

A solid tire (4; 8) is described comprising two or more circular layers overlapped in a radial direction. At least the outermost layer is made of elastic material and consists of an external portion or tread (16). The solid tire (4; 8) furthermore comprises at least one layer for indicating excessive wear (10), arranged in a predefined position inside the outermost portion or tread (16). The layer for indicating excessive wear (10) is made in a colour different from the one of the external portion or tread (16). The layer for indicating excessive wear (10) is made with a specific compound of materials. This specific compound of materials makes the layer for indicating excessive wear (10) easy to see. This specific compound of materials also makes the solid tire (4; 8) less hysteretic, and therefore less subject to the development of heat, when compared to similar solid tires.

This application claims priority to Italian Patent Application No. 102019000020092 filed on Oct. 30, 2019, which is incorporated herein by reference.

### TECHNICAL FIELD

The present invention generally concerns a solid tire and, in particular, a solid tire provided with means capable of signalling the excessive wear thereof. Even more in particular, the invention concerns a solid tire provided with means for visually signalling the state of excessive wear.

As is known, in industrial and commercial applications tires that are not inflated with air, but are provided with a structure made of solid rubber and plastic composites, are often used. This structure, obtained by moulding operations, is particularly resistant to punctures and has an increased load capacity. By way of is example, the solid tires are used on various types of industrial vehicles and operating means. In particular, one of the most common applications for solid tires is that of equipment for handling materials (forklifts).

### BACKGROUND

A first type of solid tire is represented by the so-called super-elastic tires or “resilient tires”. Structurally, with reference to FIG. 1, in which the thickness of a super-elastic tire according to the prior art is shown in a cross-sectional view, this type of tire, indicated as a whole by the reference numeral 2, is formed by two or more circular layers made of elastic material and overlapped in a radial direction. These layers form, proceeding from the centre of the super-elastic tire 2 towards the periphery, and internal portion named bead 12, an intermediate portion simply named middle portion 14 and an external portion named tread 16.

In particular, the bead 12 is the portion of the super-elastic tire 2 that is mounted around the wheel rim, which in turn is made integral with the axle that brings the wheel into rotation, whereas the tread 16 is the portion of the structure of the super-elastic tire 2 that comes into contact with the ground on which the wheel rotates. The middle portion 14 is instead the portion of the structure which is delegated with the function of guaranteeing the elasticity of the super-elastic tire 2. For the aforementioned reasons, the bead 12 and the tread 16 must be manufactured with particularly resistant materials.

More in particular, the structure of the super-elastic tire 2 can be reinforced by a plurality of metal strands 18 at the bead 12, whereas the tread 16 can be slick or can be provided with grooves 20 the number, shape and depth of which vary according to the use intended for the super-elastic tire 2.

In the case of super-elastic tires designed to be used on low speed vehicles (typically less than 25 km/h), the function of the grooves of the tread is nevertheless of little importance. In fact, the service life of this type of super-elastic tire does not depend upon the wear of the grooves of the tread, but rather on the wear of the tread itself in its totality. The middle portion, in fact, if deprived of the coverage offered by a sufficient thickness of the tread, is not capable of guaranteeing characteristics appropriate for the use of the super-elastic tire.

For this reason, with reference again to FIG. 1, the super-elastic tires 2 are equipped with indicators of excessive wear, consisting of a raised circular portion 22 which is arranged on the shoulder of the super-elastic tire 2, namely on the lateral part of the super-elastic tire 2, in particular to the sides of the area in contact between the tread 16 and the middle portion 12. Each of these raised circular portions 22, that have the function of indicating the excessive wear, is known with the name “60J line”.

However, often users of the super-elastic tires are asked to replace them with new tires when the level of wear has reached the bottom of the grooves of the tread. According to the type of super-elastic tire, namely according to the type of use it is intended for, the bottom of the grooves of the tread is reached well before reaching the excessive point of wear of the super-elastic tire. In other words, the bottom of the grooves can be reached well before reaching the “60J line”. In some cases, the thickness of the remaining tread useful for protecting the middle portion and ensuring the correct operation of the super-elastic tire can be equal to even 20-40% of the initial thickness. Consequently, the users of this type of super-elastic tire are wrongly complaining that the actual service life does not correspond to the one declared by the manufacturer. In light of what has been described above, it will become clear that the solution offered by indicators of excessive wear according to the prior art, and in particular by the “60J line”, do not meet the need of indicating to the user the actual reaching of the end of the service life of this type of super-elastic tire.

Therefore, super-elastic tires provided with means for visually signalling the state of excessive wear have been achieved. These means for visually signalling the state of excessive wear allow users to exploit the super-elastic tire to the limit of its potentiality, namely until reaching the end of the actual service life of the super-elastic tire itself. For example, the document GB 2505034 A, filed in the name of the same applicant, shows a super-elastic tire provided with means for visually signalling the state of excessive wear. These visually signalling means have colours that are different from the colour of the tread, in order to efficiently signal the actual reaching of the end of service life of the super-elastic tire and, at the same time, to sufficiently reassure the user that the excessive state of wear has not yet been reached.

A second type of solid tire is furthermore known, known with the acronyms POS (“Press On Steel”) or POB (“Press On Band”). Structurally, with reference to FIG. 3, wherein the thickness of a POS/POB tire according to the prior art is shown in a cross-sectional view, this type of tire, indicated as a whole with the reference numeral 6, is always formed of two or more circular layers overlapped in a radial direction. These layers are not however all made of elastic material. Proceeding from the centre of the POS/POB tire 6 towards the periphery, the following can in fact be identified: an internal portion consisting of a metal ring 24, configured to simplify the mounting of the POS/POB tire 6 around the wheel rim, and the normal external portion or tread 16, which is made of elastic material and is fitted around the metal ring 24.

The difference between a POS/POB tire and a super-elastic tire consists in the fact that for the POS/POB tire no maximum limit of wear for the tread has been clearly and officially established. There is only one recommendation from the European Tire and Rim Technical Organization (ETRTO), which identifies this wear limit at ⅓ of the tread thickness. A similar US association (TRA or “Tire and Rim Association”) does not, however, provide any recommendations for this type of solid tire.

Identifying the wear limit of the tread of a POS/POB tire is therefore entrusted to the manufacturer of the POS/POB tire. For example, again with reference to FIG. 3, the POS/POB tire 6 can be provided, in a predefined position inside the corresponding tread 16, with a so-called wear limit 26 which is designed to indicate the point of excessive wear of the tread 16 itself. In other words, once the wear limit 26 is reached, after deterioration of the tread 16, the POS/POB tire 6 must be replaced.

Means for visually signalling the state of excessive wear have also been disclosed for POS/POB tires, such as, for example, those shown in the document WO 2019/092756 A1 filed in the name of the same applicant. The applicant has, however, observed that these visual signalling means, whether mounted on super-elastic tires or on POS/POB tires, can be manufactured with a particularly bright colour, and therefore easier to see, if fabricated with a specific compound of materials. In addition, this specific compound of materials can also make the visual signalling means, and consequently also the entire solid tire, less hysteretic and therefore less subject to the development of heat.

### SUMMARY

An object of the present invention is therefore that of manufacturing a solid tire that is able to solve the aforementioned drawbacks of the prior art in an extremely simple, inexpensive and particularly functional manner.

In detail, an object of the present invention is that of manufacturing a solid tire provided with means for visually signalling the excessive state of wear which are easier to see compared to similar solid tires of a known type.

Another object of the present invention is that of manufacturing a solid tire provided with means for visually signalling the state of excessive wear which are resistant compared to similar solid tires of a known type.

These and other objects according to the present invention are achieved by manufacturing a solid tire as disclosed in claim 1.

Further characteristics of the invention are outlined in the dependent claims, which form an integral part of the present invention.

### BRIEF DESCRIPTION OF THE DRAWINGS

The characteristics and advantages of a solid tire according to the present invention will be clearer from the following description, which is explanatory and nonlimiting, with reference to the attached schematic drawings, in which:

FIG. 1 is a cross-sectional view of the thickness of a super-elastic tire according to the prior art;

FIG. 2 is a cross-sectional view of the thickness of a first example of an embodiment (super-elastic tire) of a solid tire provided with means for visually signalling the state of excessive wear according to the present invention;

FIG. 3 is a cross-sectional view of the thickness of a POS/POB tire according to the prior art; and

FIG. 4 is a cross-sectional view of the thickness of a second embodiment (POS/POB tire) of a solid tire provided with means for visually signalling the state of excessive wear according to the present invention.

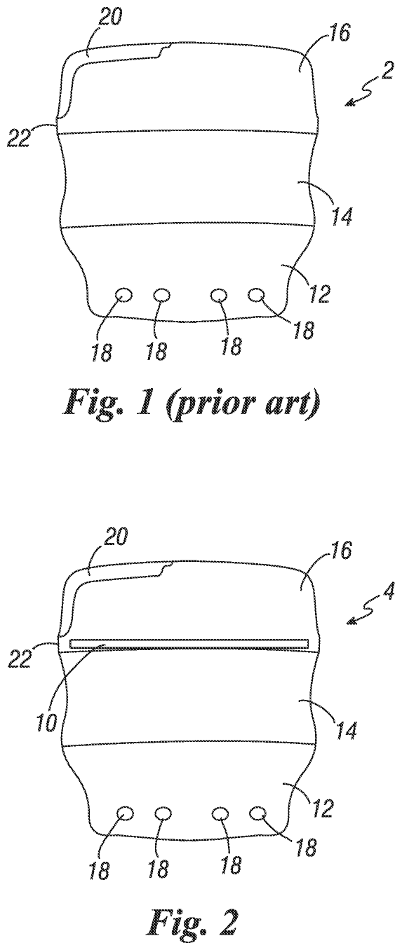

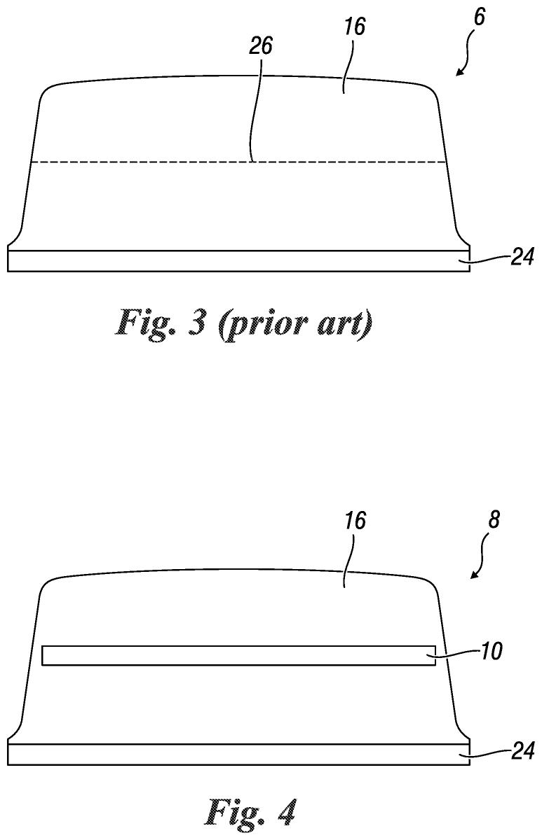

### DETAILED DESCRIPTION

With particular reference to FIGS. 2 and 4, two preferred embodiments of a solid tire according to the present invention are shown. In detail, in FIG. 2 the solid tire consists of a super-elastic tire, indicated as a whole by the reference numeral 4, whereas in FIG. 4 the solid tire consists of a POS/POB tire, indicated as a whole by the reference numeral 8.

Both the super-elastic tire 4 and the POS/POB tire 8 are substantially formed by the same parts that respectively form the super-elastic tires and the POS/POB tires according to the prior art. The same reference numerals previously stated have therefore been used for these parts. Therefore, in general, the solid tire 4 or 8 comprises two or more circular layers overlapped in a radial direction, wherein at least the outermost layer is made of an elastic material and consists of an external portion or tread 16.

The solid tire 4 or 8 comprises, in addition, at least one layer for indicating excessive wear 10, arranged in a predefined position inside the external portion or tread 16. For example, in the super-elastic tire 4 the layer for indicating excessive wear 10 can be positioned in the external portion or tread 16 at the raised circular portion 22 (“60J line”), whereas in the POS/POB tire 8 said layer for indicating excessive wear 10 can be positioned in the external portion or tread 16 at the wear limit 26.

The layer for indicating excessive wear 10 is in any case made with a colour that can be clearly distinguished from the colour of the tread 16. In particular, the layer for indicating excessive wear 10 is made with a colour different from that of the tread 16. In this manner, when the wear of the tread 16 is such that the layer for indicating excessive wear 10 becomes exposed, it is immediately and easily visible.

According to the invention, the layer for indicating excessive wear is manufactured with the following compound of materials in the following percentages by weight:
rubber: 50%/60%;
silica: 20%/30%;
one or more plasticising additives: 2%/8%;
one or more compatibilizing agents between rubber and silica: 2%/3%;
pigments: 3%/8%;
one or more protective agents: 1%;
one or more crosslinking agents: 3%/8%.

The rubber can be both of a synthetic type and a natural type. Mineral binders are also added to the pigments, so that the binding of pigments with mineral binders gives rise to a mineral colour.

In particular, the protective agents are of the so-called “no-staining” type and contribute to keeping the mineral colour brighter, thus avoiding at the same time the migration of colouring components onto the surface of the compound. The protective agents furthermore contribute to reducing the ageing effect of the rubber. A special category of non-staining protective agents, typically used in the compound, consisting of the category of the hindered phenols known, for example, with the commercial names “Wingstay L” and “Lowinox GP 45”.

One of the main performance requirements of a solid tire is its resistance to accumulation of heat. During its use, the solid tire is continuously subject to cycles of fatigue due to its rotational speed and the combinations of loads that bear thereon. These cycles of fatigue generate heat, which accumulates inside the solid tire. If the work cycles are long and if each lasts more than eight hours a day, the solid tire does not have time to rest and cool down. If the internal temperature of the solid tire exceeds 130° C., its ageing is accelerated and the solid tire can degrade more easily.

The silica and the compatibilizers between rubber and silica (that can be selected from the category of silanes such as, for example, vinyltrimethoxysilane) create a special compound that makes the solid tire 4 or 8 less hysteretic, and therefore less subject to the development of heat, when compared to similar solid tires according to the prior art. In fact, since the layer for indicating excessive wear 10 comprises the aforementioned compound, said layer for indicating excessive wear 10 generates a discontinuity in the solid tire 4 or 8, reducing the accumulated heat and making the solid tire 4 or 8 suitable for heavy duty (2-3 consecutive shifts or work cycles of 18-24 hours).

It has thus been seen that the solid tire according to the present invention has achieved the aforementioned objects.

The solid tire of the present invention thus conceived is however susceptible to numerous modifications and variations, all falling within the same inventive concept; furthermore, all the details are replaceable with technically equivalent elements. In practice the materials used, as well as the shapes and sizes, can be of any type according to the technical needs.

The scope of protection of the invention is therefore defined by the attached claims.

1. A solid tire (4; 8) comprising two or more circular layers overlapped in a radial direction, wherein at least the outermost layer is made of an elastic material and consists of an external portion or tread (16), wherein said solid tire (4; 8) further comprises at least one layer for indicating excessive wear (10), arranged in a predefined position inside said external portion or tread (16), and wherein said at least one layer for indicating excessive wear (10) is made with a colour different from that of said external portion or tread (16), said solid tire (4; 8) being characterized in that said at least one layer for indicating excessive wear (10) is manufactured with the following compound of materials in the following percentages by weight:
rubber: 50%/60%;
silica: 20%/30%;
one or more plasticising additives: 2%/8%;
one or more compatibilizing agents between rubber and silica: 2%/3%;
pigments: 3%/8%;
one or more protective agents: 1%;
one or more crosslinking agents: 3%/8%,
wherein mineral binders are added to the pigments, in such a way that the binding of said pigments and said mineral binders gives rise to a mineral colour.

2. The solid tire (4; 8) according to claim 1, characterized in that the rubber is of the synthetic type.

3. The solid tire (4; 8) according to claim 1, characterized in that the rubber is of the natural type.

4. The solid tire (4; 8) according to claim 1, characterized in that the protective agents of the so-called “no-staining” type and contribute to keeping said mineral colour brighter, thus avoiding the migration of colouring components onto the surface of the compound.

5. The solid tire (4; 8) according to claim 4, characterized in that the protective agents are selected in the category of the hindered phenols.

6. The solid tire (4; 8) according to claim 1, characterized in that the compatibilizing agents between rubber and silica are selected in the category of silanes.

7. The solid tire (4; 8) according to claim 1, characterised in that it consists of a super-elastic tire (4) comprising a plurality of circular layers of elastic material overlapped in a radial direction, said layers forming, proceeding from the centre of the super-elastic tire (4) towards the periphery, an internal portion or bead (12), an intermediate portion or middle portion (14) and said external portion or tread (16).

8. The solid tire (4; 8) according to claim 7, characterized in that it further comprises a raised circular portion (22), arranged on the shoulder of the super-elastic tire (4) at the sides of the contact area between said external portion or tread (16) and said intermediate portion or middle portion (14).

9. The solid tire (4; 8) according to claim 8, characterized in that said at least one layer for indicating excessive wear (10) is positioned in said external portion or tread (16) at said raised circular portion (22).

10. The solid tire (4; 8) according to claim 1, characterized in that it consists of a POS/POB tire (8) comprising, proceeding from the centre of the POS/POB tire (8) towards the periphery, an internal portion consisting of a metal ring (24) and said external portion or tread (16), which is fitted around said metal ring (24).

11. The solid tire (4; 8) according to claim 10, characterized in that it further comprises, in a predefined position inside said external portion or tread (16), a wear limit (26) which is designed to indicate the point of excessive wear of said external portion or tread (16).

12. The solid tire (4; 8) according to claim 11, characterized in that said at least one layer for indicating excessive wear (10) is positioned in said external portion or tread (16) at said wear limit (26).
